(19) United States
(12) Patent Application Publication
(10) Pub. No.: US 2026/0210318 A1
(43) Pub. Date: Jul. 23, 2026

(54) FUEL INJECTOR FOR DIRECT INJECTION OF GASEOUS FUEL

(71) Applicant: PHINIA DELPHI LUXEMBOURG SARL, Belvaux (LU)

(72) Inventors: Manfred KOLKMAN, Messancy (BE); François DIDIER, Blois (FR)

(21) Appl. No.: 19/144,179

(22) PCT Filed: Dec. 22, 2023
(86) PCT No.: PCT/EP2023/087675

§ 371 Date: Jun. 27, 2025

(30) Foreign Application Priority Data
Jan. 13, 2023 (GB) 2300523.4

(51) Int. Cl. F02M 21/02

(52) U.S. Cl. CPC F02M 21/0254; F02M 21/0275

(57) ABSTRACT

A fuel injector for direct injection of gaseous fuel is provided. The fuel injector extends along an axial direction from a proximal side to a distal side and includes: an injector body defining a fuel passage and having a distally disposed end portion that defines a valve seat extending around an outlet opening; an outward opening pintle received in the injector body to be axially movable between a proximal pintle position, in which it engages the valve seat to close the outlet opening and a distal pintle position, in which it releases the outlet opening; an armature element being axially movable from a proximal armature position to a distal armature position in a distal movement, in which it moves the pintle into the distal pintle position, and back to the proximal armature position in a proximal movement; and an actuator element adapted to initiate the distal movement. In order to provide reliable means for preventing impact damage in an injector valve of an injector for gaseous fuel, a damping space is at least partially defined by the armature element and the injector body, which damping space is increased by the proximal movement, and wherein a valve mechanism is adapted to at least partially close a connecting path between the damping space and the fuel passage during the proximal movement and to open the connecting path during the distal movement.

### TECHNICAL FIELD

The present invention relates to a fuel injector for direct injection of gaseous fuel.

### BACKGROUND OF INVENTION

For automotive applications, hydrogen engines are considered as a promising alternative to gasoline or diesel engines since the emissions from a hydrogen engine consist mainly of water. However, using hydrogen as a fuel in a combustion engine brings about several difficulties as compared to liquid fuels like gasoline or diesel. Specifically, while liquid fuel provides a considerable damping effect, in particular due to squeeze damping, such damping is negligible for a gaseous fuel. Accordingly, when a moving part of the injector engages another part during its movement in the injection cycle, the resulting impact is much more severe than in a comparable injector for liquid fuel. Also, the mass of the moving elements is oftentimes greater than in a liquid-fuel injector, which also increases the forces acting during impact. Over time, this may lead to deformation or even failure of a component. In particular, the injector valve may lose its sealing properties due to deformations of the injector pintle or the valve seat which the pintle engages during each injection cycle. The resulting injector leakage normally necessitates the replacement of the injector.

One option to alleviate this problem would be to reduce the closing speed of the pintle. In principle, this is possible by a brief electrical re-activation of the injector/solenoid during closing. This so-called “soft-landing pulse” helps to slow down the pintle and thus reduce the impact load. However, it is difficult to sense the best timing for the pulse, wherefore satisfactory control of the pintle movement is hardly possible for the entire operating range of the injector.

### TECHNICAL PROBLEM

It is thus an object of the present invention to provide reliable means for preventing impact damage in an injector valve of an injector for gaseous fuel.

### GENERAL DESCRIPTION OF THE INVENTION

The invention provides a fuel injector for direct injection of gaseous fuel. In other words, the fuel injector is designed for an engine that is adapted for gaseous fuel. “Gaseous fuel” normally refers to a fuel that is gaseous under standard conditions, i.e., 15° C. and 101,325 Pa. Specifically, the gaseous fuel may be hydrogen (H₂). The fuel injector is adapted for direct injection of the gaseous fuel into a combustion chamber of a cylinder of the respective engine. However, this does not exclude the possibility that the fuel injector could be used for indirect injection.

The fuel injector extends along an axial direction from a proximal side to a distal side. The axial direction can correspond to an injector axis, which may be a symmetry axis of at least some parts of the fuel injector. When the fuel injector is installed to the engine, the proximal side is the side that faces away from the engine, while the distal side faces the engine. The general flow direction of the fuel is from the proximal side to the distal side.

The fuel injector comprises an injector body defining a fuel passage and having a distally disposed end portion that defines a valve seat extending around an outlet opening. The fuel passage extends through the injector body and communicates with the outlet opening, which is disposed on the distal side of the injector body. During operation, fuel is ejected/discharged from the fuel passage through the outlet opening. The end portion of the injector body at the distal side defines a valve seat that extends around the outlet opening. As a rule, the injector body comprises several components that are connected to each other. Several components or portions of the injector body may be made of metal, normally stainless steel. Normally, the valve seat and the outlet opening are symmetric with respect to the abovementioned symmetry axis of the fuel injector. Also, the fuel passage can be symmetric with respect to this axis. Usually, at least the end portion of the injector body is adapted to be inserted into a through-opening of a cylinder head, with the outlet opening being disposed near the inside of the cylinder head, i.e., near the combustion chamber.

The fuel injector further comprises an outward opening pintle received in the injector body to be axially movable between a proximal pintle position, in which it engages the valve seat to close the outlet opening, and a distal pintle position, in which it releases the outlet opening. The pintle is normally received in the injector body so that it can slide along the axial direction. The term “outward opening” refers to a pintle that moves outward with regard to the fuel passage as it opens, i.e., towards the cylinder. In the proximal pintle position, the pintle engages the abovementioned valve seat (in a gas-tight manner) to prevent fuel from exiting the fuel passage. In other words, it is in contact with the valve seat. In the distal pintle position, it is at least partially disengaged from the valve seat to release the outlet opening. It thereby opens the fuel passage via the outlet opening to discharge gas. In other words, it is at least partially out of contact with the valve seat. In this position, it releases, clears or unblocks the outlet opening. The proximal pintle position can therefore be referred to as a closed position and the distal pintle position can be referred to as an open position. As a rule, the pintle is also made of metal like stainless steel.

Further, the injector comprises an armature element being axially movable from a proximal armature position to a distal armature position in a distal movement, in which it moves the pintle into the distal pintle position, and back to the proximal armature position in a proximal movement. The armature element may be made of a single piece or of several pieces, which are fixedly connected. It may be adapted for engaging the pintle from the proximal side, i.e., it may be at least partially disposed proximally of the pintle. This includes the possibility that it permanently engages the pintle or may even be fixedly connected thereto. The armature element is movable within the injector body. As it is moved from the proximal armature position to the distal armature position, which is herein referred to as the distal movement, it moves the pintle into the distal pintle position (i.e., the open position). During the distal movement, the armature element exerts a distal force on the pintle. It may push or pull the pintle into the distal pintle position. As it moves from the distal armature position to the proximal armature position in the proximal movement, the pintle can move back to the proximal pintle position (i.e., the closed position).

The injector also comprises an actuator, e.g., comprising a solenoid, adapted to initiate the distal movement. The solenoid is activatable to generate a magnetic field. This, in turn, moves the armature element from the proximal armature position towards the distal armature position. As a rule, the magnetic field magnetizes at least some components of the injector body, thereby creating magnetic attraction. Specifically, the armature element can be pulled towards the distal side.

A damping space is at least partially defined by the armature element and the injector body, which damping space is increased by the proximal movement, wherein a valve mechanism is adapted to at least partially close a connecting path between the damping space and the fuel passage during the proximal movement and to open the connecting path during the distal movement. The damping space is defined or delimited by the armature element, the injector body and possibly at least one additional element. During the proximal movement, the damping space increases, i.e., its volume increases. More specifically, the damping space increases due to the proximal movement of the armature element. At least temporarily, the damping space can communicate with the fuel passage via the connecting path. In general, the connecting path is a space or passage that allows for gas exchange between the fuel passage and the damping space. While the connecting path is open, gaseous fuel can be transferred from the fuel passage to the damping space and vice versa. However, a valve mechanism is adapted to entirely or partially close the connecting path during the proximal movement. This includes the possibility that the connecting path remains open during an early phase of the proximal movement and is then closed for a later phase. Preferably, the connecting path is closed predominantly, i.e., its cross section is reduced by more than 50%, typically by more than 90%. More preferably, the connecting path is fully closed. As the connecting path is closed, gas exchange between the fuel passage and the damping space is reduced, possibly to a negligible amount. Accordingly, as the damping space increases, an underpressure is generated with respect to the fuel passage. This underpressure counteracts the proximal movement of the armature element. As soon as the connecting path is closed, a pneumatic damping or braking effect commences, which reduces the speed of the armature element compared to a design without the valve mechanism. One could also say that the proximal acceleration of the armature element is reduced, possibly even leading to a distal acceleration. As a consequence, the speed of the pintle is also reduced, which leads to a less severe impact between the pintle and the valve seat. On the other hand, when the armature element moves to the distal armature position and the pintle moves to the distal pintle position, the connecting path is opened to allow for free gas exchange between the damping space and the fuel passage. Accordingly, the damping space leads to no or only minor damping during the distal movement.

The inventive injector employs pneumatic damping. The working fluid for the damper is the gaseous fuel that is available in the injector during operation at all times, i.e., no additional working fluid is necessary. The valve mechanism allows for a reliable activation of the damping effect. As will become apparent below, the valve mechanism does not require any sensor or actuator for its control. Accordingly, a properly timed damping effect can be achieved with comparatively simple, mechanical means.

In general, the valve mechanism could be realized in various ways. For instance, it could comprise a one-way valve in the connecting path, wherein the one-way valve closes in response to an under pressure in the damping space. However, a more accurate timing of the damping effect can be realized if the armature element itself is integrated into the valve mechanism. According to a preferred embodiment, the valve mechanism comprises the armature element, wherein the armature element is adapted to at least partially close the connecting path by the proximal movement and to open the connecting path by the distal movement. Accordingly, there is a causal relationship between the movement of the armature element and the damping effect.

Preferably, the valve mechanism comprises a piston element received in the injector body to be axially movable between a proximal piston position and a distal piston position, wherein the piston element partially defines the damping space and has a first contact surface disposed proximally of a second contact surface of the armature element, which contact surfaces engage during the proximal movement and disengage during the distal movement. The piston element is at least partially disposed proximally of the armature element. It has a first contact surface that can engage a second contact surface of the armature element. These contact surfaces disengage during the distal movement, which is due to the fact that the armature element accelerates faster than the piston element. In other words, an accelerating force acting on the piston element is adapted so that the resulting acceleration is smaller than the acceleration of the armature shaft caused by the magnetic action of the solenoid. The piston element partially defines the damping space. More specifically, it may define or delimit the damping space between the injector body and the armature element. While the piston element is axially movable within the injector body, it is preferred that it is sealingly connected to the injector body. The connection normally allows for no or only negligible gas flow between the piston element and the injector body. The overall shape of the piston element may be annular, and it may be disposed circumferentially around the fuel passage.

Preferably, the connecting path comprises an axial gap disposed between the first contact surface and second contact surface during the distal movement. The axial gap extends in the axial direction. It normally extends circumferentially around the fuel passage. The axial gap is created by the above-mentioned higher acceleration of the armature shaft. Since both the armature shaft and the piston element partially define the damping space, opening the axial gap creates an opening in the damping space towards the fuel passage. In other words, the axial gap is at least a part of the connecting path. Preferably, the connecting path is identical to the axial gap.

Reliable contact of the first and second contact surfaces during the proximal movement can be provided if a distal force acts on the piston element. According to a preferred embodiment, a piston spring biases the piston element towards the distal piston position. By the action of the piston spring, the piston element is pressed against the armature element. However, it will be understood that the piston spring is designed so that the piston element is accelerated slower than the armature element during the distal movement. Although reference is made to “a piston spring” , it will be understood that a plurality of piston springs could be employed. Normally, the piston spring is interposed between the injector body and the piston element. Preferably, the piston spring is a coil spring made of spring steel, but other materials or designs are possible, too.

The piston spring could act as a pulling spring that engages the piston element from the distal side and pulls it towards the distal piston position. However, such a design is difficult to realize. A more preferred embodiment provides that the piston spring engages the piston element from the proximal side. Accordingly, the piston spring acts as a pressure spring. This pressure spring may be compressed between the injector body and the piston element. In contrast to a pulling spring, the pressure spring may simply rest against the piston element without requiring any special connection.

It is highly preferred that the axial gap is present when the piston element is in the distal piston position and the armature element is in the distal armature position. Accordingly, when the armature element starts its proximal movement, it takes some time before the axial gap is closed. In other words, the initial phase of the proximal movement takes place without any damping effect. This is beneficial in that the closing time of the injector is reduced. As soon as the armature element makes contact with the piston element, the axial gap is closed and the damping effect begins.

The axial length of the axial gap and thus, the duration of the un-damped phase of the proximal movement, can be chosen in various ways. If the gap is extremely small, this may lead to an unnecessarily prolonged closing time of the injector. If the gap is too great, the damping effect may be insufficient to prevent damage to the pintle or valve seat. Preferably, an axial length of the axial gap corresponds to between 10% and 50% of a stroke length of the armature element. It will be understood that this pertains to a state in which the armature element is in the distal armature position and the piston element is in the distal piston position. The stroke length of the armature element is the axially distance between the proximal armature position and the distal armature position.

The armature element preferably comprises an armature shaft and an armature that is circumferentially disposed around the armature shaft and fixedly connected thereto and that comprises a third contact surface which engages a fourth contact surface of pole piece when the armature shaft is in the distal armature position, which pole piece is magnetizable by the solenoid. Specifically, one could say that the positions of the third and fourth contact surfaces define the distal armature position. When these contact surfaces engage, the armature cannot be moved any further to the distal side, and since it is fixedly connected to the armature shaft (e.g., by welding), the armature shaft cannot move any further to the distal side either. The general shape of the armature may be annular. It is also received in the injector body and is axially movable. The armature shaft can be elongate in the axial direction. It normally comprises the second contact surface. The pole piece can be regarded as a part of the injector body or is at least fixedly connected to the injector body. It is normally circumferentially disposed around the fuel passage. When the solenoid is activated, the pole piece is magnetized, thereby magnetically attracting the armature.

According to one embodiment, the armature shaft comprises a hollow sleeve portion disposed around a shaft channel, wherein the second contact surface is disposed on the proximal side of the sleeve portion. The overall shape of the sleeve portion can be cylindrical. The abovementioned armature can be fixed to an outside of the sleeve portion. The proximal side of the sleeve portion forms the second contact surface. The area of this second contact surface may be comparatively small. However, there is usually no severe impact between the first and second contact surface, wherefore even a small surface, corresponding to a thin-walled sleeve portion does not undergo excessive stress.

The injector body preferably comprises a guide element circumferentially disposed around the armature shaft, wherein the piston element comprises a fifth contact surface that engages a sixth contact surface of the guide element from the proximal side when the piston element is in the distal piston position. The overall shape of the guide element is annular, and it may protrude radially inwards from an adjacent portion of the injector body. For assembly reasons, the guide element is usually a separately manufactured element that is connected to the rest of the injector body, e.g., by press-fitting or welding. While it may at least partially be made of metal, e.g., stainless steel, it may comprise a guide bearing that is disposed next to the armature shaft and that is made of a different material, e.g., a ceramic, a polymer or the like. By the position of the guide element and its sixth contact surface, the distal piston position of the piston element is defined. When the fifth contact surface engages the sixth contact surface, the piston element cannot move any further.

As a rule, the pintle is biased towards the proximal pintle position by a pintle spring. The pintle spring may be a coil spring circumferentially disposed around the pintle. It is normally a pressure spring that is interposed between the pintle and the injector body. It should be understood that the closing of the injector is caused by the action of the pintle spring. Also, during at least a part of the proximal movement, the pintle spring may act, through the pintle, the armature element and the piston element, against the above-mentioned piston spring. Accordingly, the force of the pintle spring has to be considerably greater than that of the piston spring in order to guarantee a reliable closing of the fuel injector.

While the armature element and the pintle could be fixedly connected or could even be made of a single piece, it is preferred that the armature element and the pintle are separate elements and the armature element is adapted to engage the pintle and move it distally during the distal movement and the pintle is adapted to engage the armature element and move it proximally during the proximal movement. During the injection cycle, the pintle and the armature element may be in permanent contact, or they may temporarily disengage. During the distal movement, the armature element pushes the pintle (normally against the force of the above-mentioned pintle spring) towards the distal pintle position. The proximal movement, on the other hand, is caused by the pintle (impelled by the pintle spring) pushing the armature element towards the proximal armature position.

One embodiment provides that at least one seal element is radially interposed between the piston element and the injector body. The seal element may comprise several parts or a plurality of seal elements may be employed. At least one seal element may be elastic and may be made of an elastomeric material. For instance, an outer seal element made of PTFE may be in contact with the injector body, while an inner seal element, made of an elastomeric material, is interposed between the outer seal element and the piston element. As a rule, the at least one seal element is disposed circumferentially about the injector axis.

The function of the damping space is to generate a temporary pressure difference that results in a braking force on the armature shaft. However, it is neither necessary nor desirable to maintain an underpressure in the damping space for a longer time. Even before the armature shaft begins the next distal movement and the connecting path is re-opened, a partial or full pressure equalization can be performed between the fuel passage and the damping space. One option would be that the connecting path is not fully closed. For example, one of the first and second contact surface could comprise a small recess that prevents a perfect contact with the other contact surface. Alternatively, a venting path, which is independent of the connecting path, may connect the fuel passage and the damping space, which venting path is preferably radially interposed between the armature element and the injector body. The venting path allows for some gas exchange, although it normally has a significantly smaller cross-section than the connecting path. Accordingly, gas flow through the venting path can be regarded as slow compared to the gas flow through the fully open connecting path. However, this is sufficient prevent an unnecessarily long and/or excessive underpressure, which could, e.g., negatively affect the dynamics of the armature element and the pintle. For instance, an underpressure that is effective for braking the armature shaft could potentially reverse the movement of the armature shaft-and thus, the pintle-if it continues to act after the armature shaft has reached the proximal armature position.

### BRIEF DESCRIPTION OF THE DRAWINGS

Preferred embodiments of the invention will now be described, by way of example, with reference to the accompanying drawings, in which:

FIG. 1 is a sectional view of an inventive fuel injector during a first stage of an injection event;

FIG. 1A is a detail view of FIG. 1;

FIG. 2 is a sectional view of the fuel injector during a second stage of the injection event; FIG. 2A is a detail view of FIG. 2;

FIG. 3 is a sectional view of the fuel injector during a third stage of the injection event;

FIG. 4 is a sectional view of the fuel injector during a fourth stage of the injection event; and

FIG. 5 is a sectional view of the fuel injector during a fifth stage of the injection event.

### DETAILED DESCRIPTION OF THE EMBODIMENTS

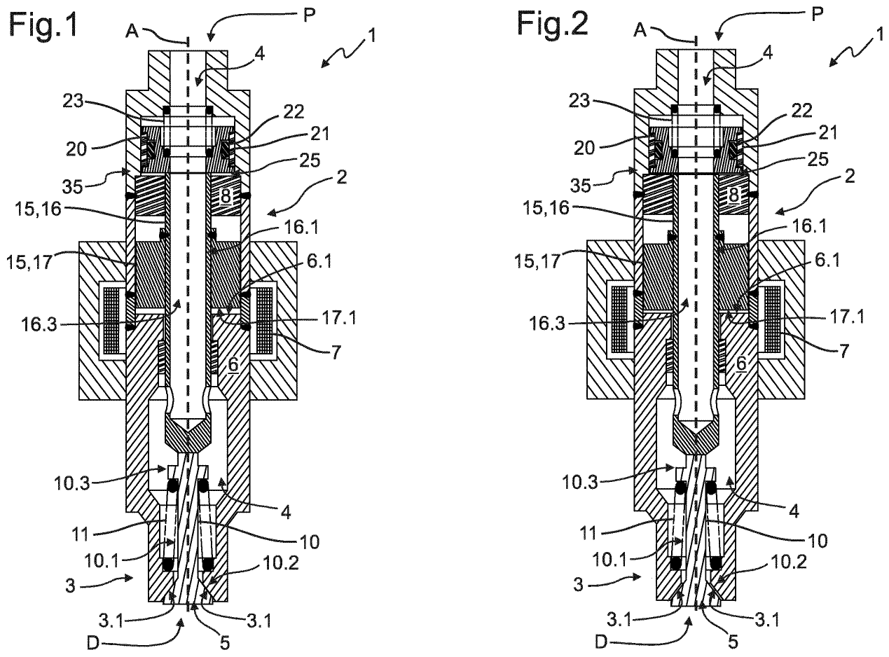

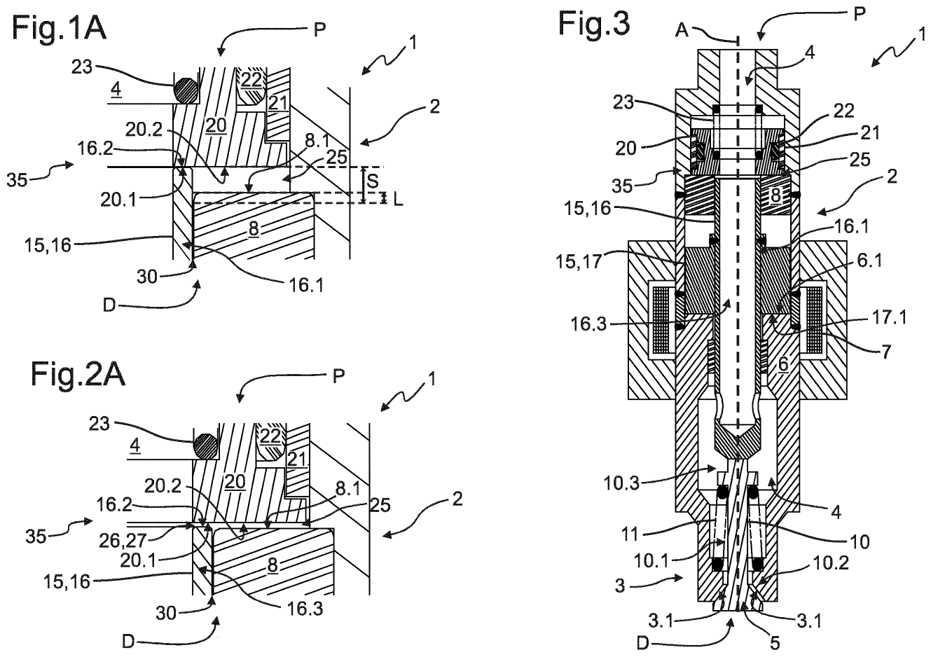

FIGS. 1-5 show a fuel injector 1 according to the present invention. The fuel injector 1 is adapted to inject a gaseous fuel, in particular H₂, into a cylinder head of a combustion engine (not shown). The fuel injector 1 is mostly symmetrical to an axial direction A. It comprises an injector body 2 that is at least partially made of stainless steel. When installed to the engine, at least an end portion 3 of the injector body 2 is inserted into a through-opening of the cylinder head. The injector body 2 defines a fuel passage 4, which extends axially from a proximal side P towards a distal side D, where it communicates with an outlet opening 5. A pintle 10 is movably received inside the injector body 2. In a closed position, which is shown in FIGS. 1 and 5, a pintle head 10.2, which radially protrudes from a pintle shaft 10.1, closes the outlet opening 5. Specifically, the pintle head 10.2 rests against a valve seat 3.1 that is formed by the end portion 3 around the outlet opening 5. The pintle 10 is also made of stainless steel. The pintle 10 is biased by a pintle spring 11 towards a proximal pintle position shown in FIGS. 1 and 5. The pintle spring 11 engages a pintle perch 10.3 that protrudes from the pintle shaft 10.1.

Proximally of the pintle 10, an armature element 15 is disposed inside the injector body 2. The armature element 15 comprises an elongate, roughly cylindrical armature shaft 16 and an annular armature 17 that circumferentially surrounds the armature shaft 16 and is connected thereto by welding. To the distal side D, the armature 17 faces a pole piece 6 which is part of the injector body 2. The pole piece 6 is magnetizable by a solenoid 7, which generates a magnetic field when it is activated. By the magnetization of the pole piece 6, the armature 17 and the entire armature element 15 can be pulled towards the distal side D in a distal movement. FIG. 1 shows the armature element 15 in a proximal armature position, in which the armature 17 and the pole piece 6 are axially spaced apart.

The armature shaft 16 comprises an elongate, hollow sleeve portion 16.1 that circumferentially surrounds a shaft channel 16.2. During operation, gaseous fuel flows through the shaft channel 16.3. The armature shaft 16 is guided by an annular guide element 8 of the injector body 2. Proximally of the armature shaft 16, a piston element 20 is received in the injector body 2. The piston element 20 has a generally annular shape and surrounds the fuel passage 4. It is axially movable between a proximal piston position shown in FIG. 1 and a distal piston position shown in FIG. 3. In the latter position, the piston element 20 engages the guide element 8. On the outer periphery of the piston element 20, two sealing elements 21, 22 are interposed between the piston element 20 and the injector body 2. An outer sealing element 21 made of PTFE is in direct contact with the injector body 2, while an inner sealing element 22 made of an elastomer material is interposed between the outer sealing element 21 and the piston element 20. A piston spring 23 biases the piston element 20 towards the distal piston position. In FIG. 1, in which the armature 15 is in the proximal armature position and the piston element 20 is in the proximal piston position, a first contact surface 20.1 of the piston element 20 is in contact with a second contact surface 16.3 that is formed at a proximal end of the sleeve portion 16.1. Also, the piston element 20 is axially spaced from the guide element 8. Accordingly, an annular damping space 25 exists, which is delimited by the injector body 2, the armature shaft 16 and the piston element 20. In this situation, the damping space 25 is largely separated from the fuel passage 4, although there is a small collection via a venting path 30 visible in FIGS. 1A and 2A. Gas exchange through this venting path 30 occurs rather slowly, though.

When the solenoid 7 is activated and magnetizes the pole piece 6, the armature element 15 is pulled towards the distal armature position in a distal movement. A third contact surface 17.1 of the armature 17 axially faces a fourth contact surface 6.1 of the pole piece 6. Since the armature shaft 16 engages the pintle 10, the pintle 10 is also pushed towards a distal pintle position and the injector 1 starts to open. The acceleration of the armature element 15 due to the magnetic attraction by the pole piece 6 is greater than the acceleration of the piston element 20 by the piston spring 23. Due to its greater acceleration and speed, the armature element 15 moves ahead of the piston element 20, and the first contact surface 20.1 disengages from the second contact surface 16.3 to form an axial gap 26. Such a state is shown in FIGS. 2 and 2A. The damping space 25 is no longer separated from the fuel passage 4 but is connected thereto by a connecting path 27 formed by the axial gap 26. Accordingly, gaseous fuel contained in the damping space 25 can be pushed out into the fuel passage 4 without much resistance. Due to the force of the piston spring 23, the piston element 20 moves further into the distal piston position shown in FIG. 3, in which a fifth contact surface 20.2 of the piston element 20 engages a sixth contact surface 8.1 of the guide element 8. The armature element 15 moves further to the distal side D until the third contact surface 17.1 of the armature 17 engages the fourth contact surface 6.1 of the pole piece 6, thereby defining the distal armature position. This state is shown in FIG. 3. In this state, the axial gap 26 is still present. In this embodiment, it has an axial length L corresponding to 20% of a stroke length S of the armature element 15, although this is to be understood as just an example.

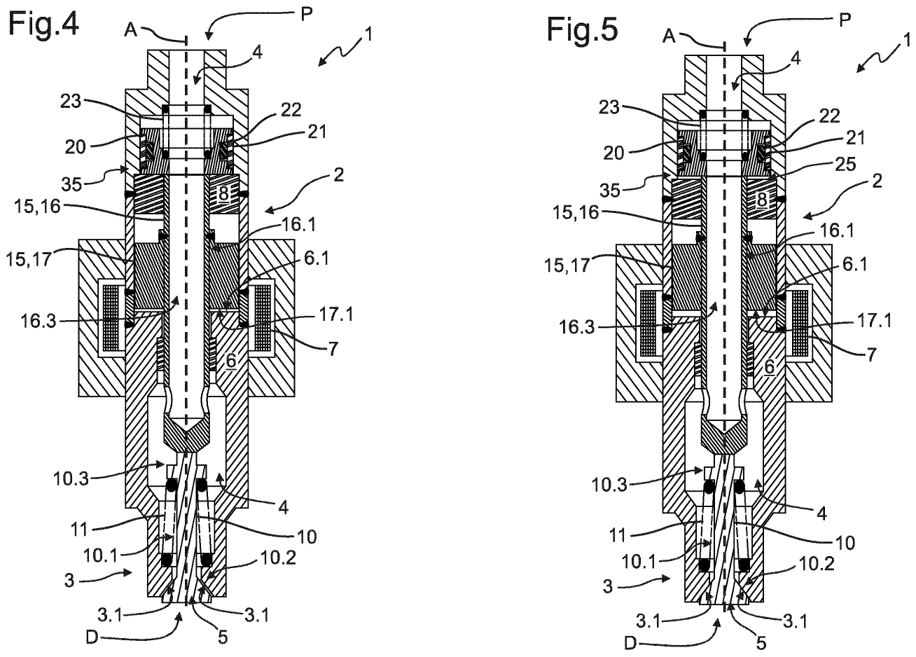

When the solenoid 7 is deactivated, the armature 17 is no longer attracted towards the pole piece 6. Accordingly, the force of the pintle spring 11 pushes the pintle 10 towards the proximal pintle position and, accordingly, the armature element 15 is pushed towards the proximal armature position in a proximal movement. During the first phase of the proximal movement, there is no contact between the armature shaft 16 and the piston element 20, wherefore the latter remains in its distal piston position. At this stage, the proximal movement is influenced-apart from friction forces-only by the force of the pintle spring 11. This changes, however, when the second contact surface 16.1 engages the first contact surface 20.1, as shown in FIG. 4. On the one hand, the pintle spring 11 now also has to push the additional mass of the piston element 20 and it acts against the force of the piston spring 23. Moreover, the abovementioned damping space 25 begins to expand as the piston element 20 is moved away from the guide element 8. Since the first contact surface 20.1 and second contact surface 16.1 engage each other, the connecting path 27 is closed. The piston element 20 and the armature 15 are parts of a valve mechanism 35 that is adapted to close the connecting path 27 during the proximal movement and to open it during the distal movement.

The only remaining connection between the damping space 25 and the fuel passage 4 is the venting path 30. As mentioned above, the venting path 30 only allows for relatively slow gas exchange. Accordingly, an underpressure builds in the expanding damping space 25, which leads to a pneumatic force acting towards the distal side D. This braking force reduces the acceleration of the armature element 15 or even reduces its speed. The same applies to the pintle 10. Therefore, when the pintle head 10.2 engages the valve seat 3.1, there is no excessive impact force that could damage the pintle head 10.2 or the valve seat 3.1 and lead to injector leakage.

FIG. 5 shows a state in which the armature element 15 has returned to the proximal armature position and the piston element 20 has returned to the proximal piston position. By the counteracting forces of the pintle spring 11 and the piston spring 23, the first contact surface 20.1 and the second contact surface 16.1 are pressed together so that the connecting path 27 remains closed until the next injection cycle. In the meantime, the pressure in the damping space 25 is adapted to the pressure in the fuel passage 4 by gas exchange through the venting path 30.

### LEGEND OF REFERENCE NUMBERS

1fuel injector
2 injector body
3 end portion
3.1 valve seat
4 fuel passage
5 outlet opening
6 pole piece
6.1 fourth contact surface
7 solenoid
8 guide element
8.1 sixth contact surface
10 pintle
10.1 pintle shaft
10.2 pintle head
10.3 pintle perch
11 pintle spring
15 armature element
16 armature shaft
16.1 sleeve portion
16.2 Second contact sleeve portion 16.2
16.3 shaft channel
17 armature
17.1 third contact surface
20 piston element
20.1 first contact surface
20.2 fifth contact surface
21,22 sealing element
23 piston spring
25 damping space
26 axial gap
27 connecting path
30 venting path
35 valve mechanism
A axial direction
D distal side
L axial length
P proximal side
S stroke length

1. A fuel injector for direct injection of gaseous fuel, extending along an axial direction from a proximal side to a distal side and comprising:
an injector body defining a fuel passage and having a distally disposed end portion that defines a valve seat extending around an outlet opening;
an outward opening pintle received in the injector body to be axially movable between a proximal pintle position, in which it engages the valve seat to close the outlet opening, and a distal pintle position, in which it releases the outlet opening;
an armature element being axially movable from a proximal armature position to a distal armature position in a distal movement, in which it moves the pintle into the distal pintle position, and back to the proximal armature position in a proximal movement; and
an actuator element adapted to initiate the distal movement,
wherein a damping space is at least partially defined by the armature element and the injector body, which damping space is increased by the proximal movement, and wherein a valve mechanism is adapted to at least partially close a connecting path between the damping space and the fuel passage during the proximal movement and to open the connecting path during the distal movement.

2. The fuel injector according to claim 1, wherein the valve mechanism comprises the armature element, wherein the armature element is adapted to at least partially close the connecting path by the proximal movement and to open the connecting path by the distal movement.

3. The fuel injector according to claim 1, wherein the valve mechanism comprises a piston element received in the injector body to be axially movable between a proximal piston position and a distal piston position, wherein the piston element partially defines the damping space and has a first contact surface disposed proximally of a second contact surface of the armature element, which contact surfaces engage during the proximal movement and disengage during the distal movement.

4. The fuel injector according to claim 3, wherein the connecting path comprises an axial gap disposed between the first contact surface and second contact surface during the distal movement.

5. The fuel injector according to claim 3, wherein a piston spring biases the piston element towards the distal piston position.

6. The fuel injector according to claim 5, wherein the piston spring engages the piston element from the proximal side.

7. The fuel injector according to claim 4, wherein the axial gap is present when the piston element is in the distal piston position and the armature element is in the distal armature position.

8. The fuel injector according to claim 4, wherein an axial length of the axial gap corresponds to between 10% and 50% of a stroke length of the armature element.

9. The fuel injector according to claim 1, wherein the armature element comprises an armature shaft and an armature that is circumferentially disposed around the armature shaft and fixedly connected thereto and that comprises a third contact surface which engages a fourth contact surface of the pole piece when the armature element is in the distal armature position, which pole piece is magnetizable by the solenoid.

10. The fuel injector according to claim 9, wherein the armature shaft comprises a hollow sleeve portion disposed around a shaft channel, wherein the second contact surface is disposed on the proximal side of the sleeve portion.

11. The fuel injector according to claim 9, wherein the injector body comprises a guide element circumferentially disposed around the armature shaft, wherein the piston element comprises a fifth contact surface that engages a sixth contact surface of the guide element from the proximal side when the piston element is in the distal piston position.

12. The fuel injector according to claim 1, wherein the pintle is biased towards the proximal pintle position by a pintle spring.

13. The fuel injector according to claim 1, wherein the armature element and the pintle are separate elements and the armature element is adapted to engage the pintle and move it distally during the distal movement and the pintle is adapted to engage the armature element and move it proximally during the proximal movement.

14. The fuel injector according to claim 3, wherein at least one seal element is radially interposed between the piston element and the injector body.

15. The fuel injector according to claim 1, wherein a venting path, which is independent of the connecting path, connects the fuel passage and the damping space radially.

16. The fuel injector according to claim 1, wherein the actuator element is a solenoid.

17. The fuel injector according to claim 1, wherein the armature element engages the pintle from the proximal side.

18. The fuel injector according to claim 15, wherein the venting path is radially interposed between the armature shaft and the injector body.
